(19) United States
(12) Patent Application Publication
(10) Pub. No.: US 2024/0367768 A1
(43) Pub. Date: Nov. 7, 2024

(54) SUBMERSIBLE VEHICLE

(71) Applicant: BLUE ECONOMY ENGINEERING LTD, Aberdeen (GB)

(72) Inventor: Michael BOWER, Aberdeen (GB)

(21) Appl. No.: 18/553,867

(22) PCT Filed: Apr. 5, 2022
(86) PCT No.: PCT/GB2022/050851

§ 371 Date: Oct. 4, 2023

(30) Foreign Application Priority Data
Apr. 6, 2021 (GB) 2104841.8

(51) Int. Cl. B63G 8/08; B63G 8/00; B63H 11/00

(52) U.S. Cl. CPC B63G 8/08; B63G 8/001; B63H 11/00; B63G 2008/004; B63G 2008/005; B63H 2011/006; B63H 2011/008

(57) ABSTRACT

A submersible vehicle (210) includes a plurality of outlet nozzles (301, 302, 303) arranged to receive pressurised fluid from a remote supply and expel the pressurised fluid to create propulsion to manoeuvre the vehicle (210); and a plurality of valves (401) in fluid communication with the outlet nozzles (301, 302, 303) and operable to provide variable pressure and/or flow to each outlet nozzle (301, 302, 303). The outlet nozzles (301, 302, 303) are arranged about the vehicle to provide six-degrees of freedom movement and control of the submersible vehicle (210).

### FIELD

The present invention relates to submersible vehicles, and more specifically to a power system to manoeuvre submersible vehicles.

### BACKGROUND

Submersible/underwater vehicles are increasingly employed in underwater work, where it is dangerous and expensive to send personnel. Underwater vehicles are used widely, for example to assist with oil and gas production, survey, military, scientific, aquaculture, and marine conservation operations. In aquaculture settings, the operating depths of such vehicles is from 0 m to around 45 m. In some other applications, underwater vehicles dive significantly deeper than 45 m.

Underwater vehicles are often remotely operated vehicles (ROVs) that receive instructions from a remote location (generally not underwater). Some underwater vehicles are autonomous, having an onboard control system.

ROVs have found use in fish farming. Previously fish enclosures would be typically inspected twice-weekly by SCUBA divers, and any dead fish would be removed to prevent spread of disease or outbreaks of sea-lice infestation. More recently, ROVs have been used to carry out inspection and removal of dead fish. In prior art document WO2019/135070, the contents of which are fully incorporated by reference herein, a device is provided for use with an underwater ROV, wherein the device comprises a mouth for sucking dead fish into a cage using water jets to provide the suction.

Typically, an underwater vehicle is launched from the side of a boat or offshore installation, or the side of a river or lake, and is controlled as an ROV by an operator at the surface. The ROV may be connected to the surface by a tether, i.e., a cord or flexible attachment. The tether may comprise an umbilical connection typically providing electrical communication between the ROV and the surface. For example, the umbilical may include one or more of: electrical power cabling; communication cabling for control of the ROV; communication cabling for transmission of video or sensor data.

Most underwater ROVs comprise a buoyancy pack, often made of syntactic foam, on top of a (typically aluminium or High-Density Polyurethane “HDPE”) chassis. A “Skid” i.e., an additional chassis may take the form of an additional framework structure. Specialised tooling or equipment can be attached to the chassis for use underwater. The chassis or skid may be fitted with sensors, cameras, lights, torque tools, probes, or any useful piece of equipment for work underwater. Electrical equipment on the chassis is typically powered and controlled by power supply and control signals delivered via the tether. Hydraulic power may also be provided by hydraulic lines in the umbilical or alternatively through a hydraulic power unit fitted to the ROV as a means to convert electrical power to hydraulic power, or as separate hydraulic lines to the equipment. Where multiple different pieces of equipment are operating simultaneously on the ROV, such as cameras and gripping tools, then each piece of equipment may be connected to a junction box or control manifold on the ROV which in turn is connected to an umbilical leading to the surface.

In terms of movement and control of underwater ROVs, thrusters are usually provided in the form of propellers to provide positional and attitude control during deployment. The thrusters are usually powered by an electrical or hydraulic connection from the surface. However, some ROVs carry a power source such as a battery or Hydraulic Power Unit to generate power to drive thrusters and rotate the propellers in the direction required for motion.

Despite the development of a wide range of options for underwater vehicles, improvements in efficiency and utility are still desired.

It is an object of the present application to provide improvements to underwater vehicles and their propulsion systems.

### SUMMARY

The present invention provides a submersible vehicle comprising: a plurality of outlet nozzles arranged to receive pressurised fluid from a remote supply and expel the pressurised fluid to create propulsion to manoeuvre the vehicle; and a plurality of valves in fluid communication with the outlet nozzles and operable to provide variable pressure and/or flow to each outlet nozzle; wherein the outlet nozzles are arranged about the vehicle to provide six-degrees of freedom movement and control of the submersible vehicle.

This arrangement is convenient because motors or other propulsion mechanisms do not need to be located under water. This simplifies the structure of the submersible vehicle which allows it to be lighter, more reliable, and easier to manufacture and maintain. Advantageously the pressurised flow of fluid is water, typically from the body of water (e.g., fresh or salt) the vehicle is disposed in, as discussed further hereafter. However, operating the vehicle in a liquid that is not fresh or salt water is also contemplated. For example, in a tank containing an aqueous solution or even a non-aqueous liquid.

Advantageously, the outlet nozzles are configured to provide propulsion of the vehicle underwater and/or on the surface. A plurality of outlet nozzles allows precision directional control and/or movement of the vehicle.

The vehicle may be a remotely operated vehicle. The remotely operated vehicle will be connectable to a remote-control unit, typically via an umbilical connection. The vehicle may be an autonomous vehicle. Where the vehicle is autonomous the control unit (e.g., a computer receiving sensor data and/or sending control signals) may be onboard the vehicle. Alternatively, the control unit may be remote from the vehicle and may be connectable to the vehicle via an umbilical connection (i.e., the vehicle may be an autonomous remotely operated vehicle). Remotely operated vehicles are useful in many industrial environments where access is difficult, dangerous or expensive. Controlling remotely and above the water (e.g., from shore, a platform or onboard a floating vessel) allows the use of non-waterproof equipment, connecting to the submersible vehicle via umbilical arrangements.

The submersible vehicle may be configured such that the propulsion provided by the flow from the outlet nozzle or nozzles provides directional control (steering and orientation) and/or movement of the vehicle from one location to another (underwater and/or on the surface). Conveniently both directional control and movement are provided by the flow from the outlet nozzle or nozzles. However mixed arrangements are envisaged. For example, movement through the water provided by an electrically driven propeller and fine directional control by the use of flow through outlet nozzles.

Each outlet nozzle may be connectable to a distinct/separate supply hose. This provides a dedicated supply of pressurised fluid for each nozzle which can provide a degree of redundancy to the system. Failure of one or more hoses may not cause complete loss of control and/or movement of the vehicle. Arrangements where a plurality of hoses are provided, with each connecting to one or more outlet nozzles are also contemplated.

The submersible vehicle may further comprise a manifold operable to receive fluid from a single supply hose, wherein the manifold provides a plurality of outlets, wherein each manifold outlet connects to a corresponding outlet nozzle and supplies pressurised fluid thereto. This provides a simple point of connection for the supply hose on the vehicle.

The outlet nozzles may be arranged such that expelled fluid from one or more outlet nozzles, or a combination of outlet nozzles produces at least one of: heave; surge; sway; roll; pitch and yaw motions of the vehicle.

Orientation of one or more of the outlet nozzles may be fixed in position on the vehicle. This can provide a propulsion arrangement without moving parts on the vehicle. Good control of a vehicle can be achieved by using a plurality of fixed outlet nozzles providing propulsion in different directions, as discussed further hereafter. Fixed outlet nozzles can be simpler in manufacture and may be more reliable as there are no moving parts on the submersible vehicle.

Alternatively, or additionally, to one or more outlet nozzles being of fixed position, the orientation of one or more of the outlet nozzles may be adjustable. This allows the user to re-orientate the nozzle between at least two positions, allowing one outlet nozzle to provide at least two different directions of fluid flow from the outlet nozzle. Thus, one moveable outlet nozzle can be used to provide propulsion in different directions. Where moveable nozzles are employed, fewer nozzles may be required to provide all the desired motions of the submersible vehicle. Nozzle adjustment may be provided, for example by means of a motor, such as an electric pneumatic or hydraulic motor. Conveniently nozzle adjustment may be powered by hydraulic power provided by the same pressurised flow of fluid supplied to outlet nozzles.

The plurality of valves may be configured to open or close the fluid flow to one or more outlet nozzles, or to adjust the flow to one or more outlet nozzles. The valve arrangement can control the propulsion generated by the fluid flow from each outlet nozzle to allow the user or control system to provide propulsion. Propulsion from a nozzle outlet controlled by a valve can be intermittent (i.e., open or closed) and/or with variable amount of force (partially open). As an alternative to a valve arrangement mounted on the vehicle to control flow from an outlet nozzle, the supply of pressurised fluid supplied by a delivery hose from the remote supply may be varied.

The submersible vehicle may include external corners and each corner may include a downward heave outlet nozzle and an upward heave outlet nozzle. Each corner may also include a translational outlet nozzle, wherein opening forward located translational outlet nozzles only or rearward located translational outlet nozzles only causes translational movement of the vehicle.

The submersible vehicle may further comprise a separate outlet nozzle, a ‘dump nozzle’, configured to release some or all of the pressurised flow of fluid being delivered from the remote supply. The dump nozzle may be configured to release fluid flow without creating a substantial amount of propulsion, or even any effective propulsion. The dump nozzle may for example be configured to release fluid from a substantially larger cross section area of nozzle than a nozzle used for propulsion.

The fluid expelled through the dump nozzle may be controlled by a dump valve. The control may be intermittent (e.g., on or off) and/or with a variable amount of force.

A dump nozzle and optional dump valve arrangement may be employed to allow a pump supplying the flow of pressurised fluid to run continuously whilst avoiding damage due to over pressurisation when one or more of the outlet nozzles are closed or partially closed.

As an alternative or an addition to the use of dump nozzle arrangements described above, the outlet nozzle or nozzles and any associated valve arrangements may be used to avoid over pressurisation, by allowing fluid to escape even when the vehicle is stationary.

For example, fluid may be allowed to release continuously from two or more nozzle outlets that act in different (e.g., opposite) directions so that there is no net force that steers or moves the vehicle from its current attitude and location in the liquid.

For example, if the buoyancy of the vehicle is less than that required to prevent sinking, then in use, one or more nozzle outlets that are directed to provide lift may be kept at least partially open. This can counteract sinking, whilst providing a constant outlet for fluid flow. Alternatively, if the vehicle is buoyant, tending to float, then outlet nozzles directed to cause diving may be kept at least partially open during submerged work.

A submersible vehicle system may include the submersible vehicle, a pump; a control unit connectable to the vehicle by an umbilical; and a hose connectable to the vehicle, wherein the hose is configured to supply pressurised water via the pump to the vehicle.

The pump may be non-submersible i.e., not water or other liquid proof. The non-submersible pump can be of any type e.g., an electrical motor or engine (e.g., petrol or diesel) driven pump. A non-submersible pump may be easier to maintain. Alternatively, a submersible pump may be employed.

A water or other liquid inlet to the pump may be configured to be located in the same body of water or other liquid as the vehicle. For example, an inlet hose extending into the water and connecting to the inlet of a non-submersible pump mounted above the water. This removes the need for an additional source of water or other fluid to be provided to the pump and allows continuous running of the pump without requiring replenishment of a stored supply of fluid.

The control unit may comprise an electrical power source and may be connected to the vehicle by an electrical umbilical for power and/or signal transmissions. The provision of an electrical power source can allow supply to onboard electrical or electronic equipment, such as valves, cameras, lights or auxiliary equipment.

The pump supplies sufficient pressure of fluid to the vehicle for creating the required propulsion for manoeuvring the vehicle at the depths the vehicle will operate.

### BRIEF DESCRIPTION OF THE DRAWINGS

The prior art and embodiments of the invention will now be described with reference to the following drawings, in which:

FIG. 1 shows a schematic view of a typical prior art ROV system;

FIG. 2 shows a schematic drawing of the ROV system in accordance with the present invention;

FIG. 3 shows a schematic drawing of the nozzle arrangement used in the ROV of FIG. 2;

FIGS. 4a and 4b show plan and side views of the downward heave nozzles used in the ROV of FIG. 2;

FIGS. 5a and 5b show plan and side views of upward heave nozzles used in the ROV of FIG. 2;

FIGS. 6a to 9b show plan and side views of the translational nozzles in use to effect various movements of the ROV of FIG. 2;

FIG. 10 shows the valve assemblies within the ROV of FIG. 2;

FIG. 11 shows the electrical connection of the valve assemblies to the control unit via the electrical umbilical;

FIG. 12 shows the fluid connection of the nozzles to the pump via the hose and valve assemblies.

### DETAILED DESCRIPTION OF THE DRAWINGS

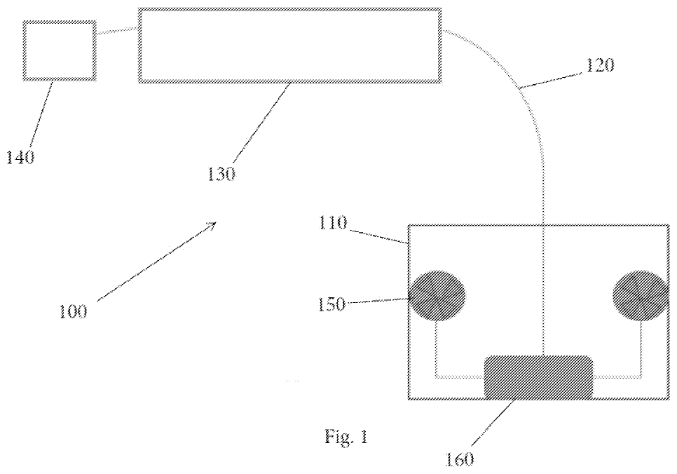

FIG. 1 shows a known (prior art) submersible remotely operated vehicle (ROV) system 100 comprising a ROV 110 connected by a length of umbilical 120 to a control unit 130 on the surface. The control unit 130 comprises an electrical power source and a computer. The umbilical 120 carries electrical power and control signals to the ROV 110 as will be explained in due course. The control unit 130 is connected to a hand controller 140 as a convenient way for an operator to control and manoeuvre the ROV 110 in operation. The control unit 130 and hand controller 140 may be combined in one unit. There may also be a winch and tether management system between the umbilical 120 and ROV 110, but in such a case the principles remain the same.

FIG. 1 is shown without a line indicating the water surface. However, it will be understood that in use the ROV 110 is positioned underwater and the control unit 130 and hand controller 140 are located above water. The ROV 110 comprises a plurality of thrusters 150, each in the form of a propeller within a housing. Typically, the ROV 110 is configured such that the electrical power is either delivered directly to the thrusters 150 to power them, or alternatively the electrical power is delivered to an electric motor and hydraulic pump assembly 160 to power the thrusters 150 electrically or with hydraulic oil.

The user typically launches the ROV 110 from a fixed or floating platform, such as a ship or oil rig, or alternatively the ROV 110 may be launched from the shore of a body of water. The ROV 110 is placed in the water and is typically lowered on a winch until the ROV 110 reaches a depth at which it is neutrally buoyant.

The user operates the hand controller 140 to manoeuvre the ROV 110 as required. The ROV 110 moves in the water by the thrusters 150 creating propulsion. The thrusters 150 may be configured to be of adjustable output, whereby increased rotational speed increases propulsion, or alternatively they may have a simple on/off output whereby the user can turn the thrusters 150 on and off individually and intermittently when movement in a particular direction is required.

Most commercial ROVs have six degrees of freedom in that they can move in three dimensions on the x, y and z axes, referred to as surge, sway and heave respectively, as well as rotate around those axes. The rotations are referred to as roll (around the x-axis), pitch (around the y-axis) and yaw (around the z-axis). The position of the thrusters 150 allows control of the ROV 110 in this regard.

Where the terms “water”, “underwater”, “submerged”, “submersible”, “liquid” and such like words are used they are to be construed as not limited to water per se, but instead any liquid within which a vehicle may be manoeuvred in. For example, submersible vehicles in accordance with the present invention may be deployed in industrial chemical tank. Furthermore, it will be understood that the same principles herein described can be applied to autonomous or semi-autonomous submersible vehicles.

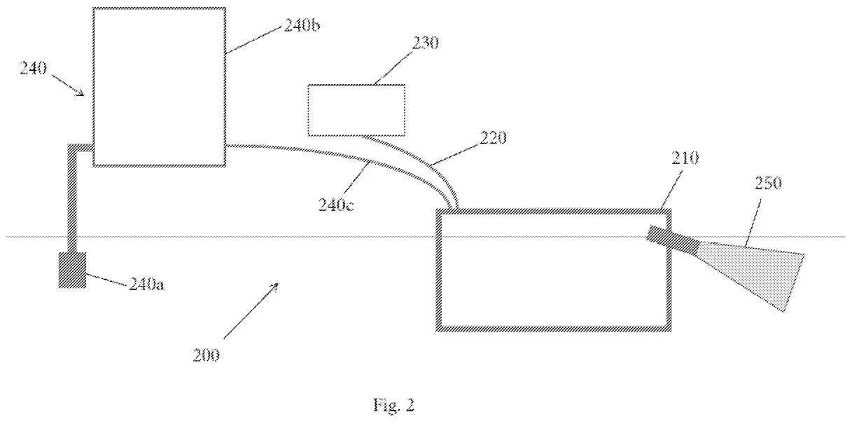

FIG. 2 shows an example of a submersible vehicle in the form of a remotely operated vehicle, and a system for moving a submersible vehicle in accordance with the present invention. The ROV system 200 comprises an ROV 210 connected by a length of umbilical 220 to a control unit 230 comprising an electrical power source. The control unit 230 further comprises an input means for the user to control the ROV 210. The input means may be in the form of a hand controller, computer, trackpad, joystick or any other suitable interface for providing instruction to the ROV 210 in use. The ROV 210 typically further comprises an auxiliary component 250, which may be for example an underwater camera, lights, sensors, to provide live data and, or video to the user, or a tool for conducting a work operation. A pressurised water system 240 is connected to the ROV 210 to provide a supply of pressurised water to the ROV 210 as will now be explained. The supplied water is provided at a sufficient pressure to provide the desired propulsion.

The pressurised water system 240 is remote from the ROV 210, in that it is not mounted on the ROV 210 or submerged within the body of water in which the ROV 210 operates. In some embodiments the pressurised water system 240 is located on a boat, a riverbank, an offshore platform, or another surface structure. It is highly advantageous to locate the pressurised water system 240 on dry land (i.e., not submerged). In use, water, from the body of water in which the ROV 210 is operating, or another body or vessel of water, is sucked into the pressurised water system 240 at a water suction inlet 240a and provided to a water pump 240b. The water is then pressurised and provided to the ROV 210 via a suitable water hose 240c. The water is delivered to nozzles positioned around the ROV 210 and is pumped out through the nozzles to create propulsion. A single hose 240c may be used to deliver fluid to the nozzles, or individual hoses (not shown) may be used to deliver fluid to the nozzles. Where a single hose is used, a manifold may split the hose into a plurality of individual lines for providing fluid to each nozzle. The water pump 240b is configured to provide water to the ROV 210 at a pressure higher than the hydrostatic pressure at the ROV 210 when submerged in use. In this regard, the water pump 240b is able to provide the ROV 210 with a flow of water which can be used to propel or steer the ROV 210 underwater.

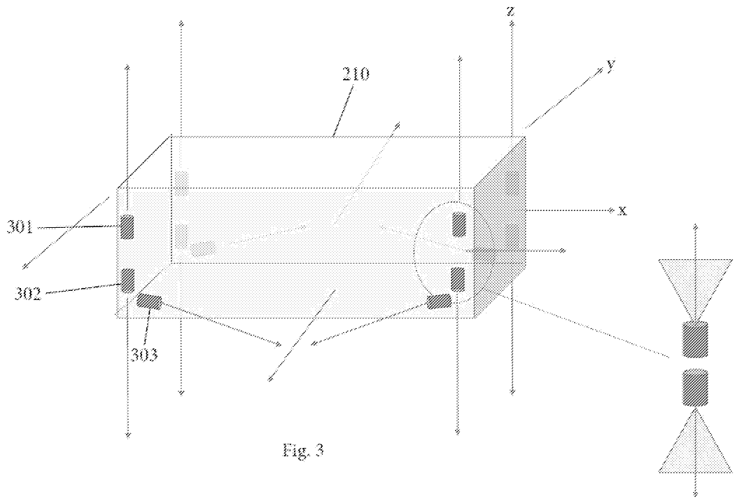

FIG. 3 shows an example arrangement of nozzles which provides six degrees of freedom movement and control of the ROV 210. The arrangement shown provides for surge on the x-axis, sway on the y-axis, heave on the z-axis as well as roll around the x-axis, pitch around the y-axis and yaw around the z-axis, as will now be explained.

### Heave

Each corner of the ROV 210 is provided with a downward heave nozzle 301 and an upward heave nozzle 302, each of which is positioned substantially vertically, i.e. longitudinally in the z-axis, such that a pressurised jet from the downward heave nozzle 301 creates downward propulsion and a high-pressure water jet from the upward heave nozzle 302 creates upward propulsion.

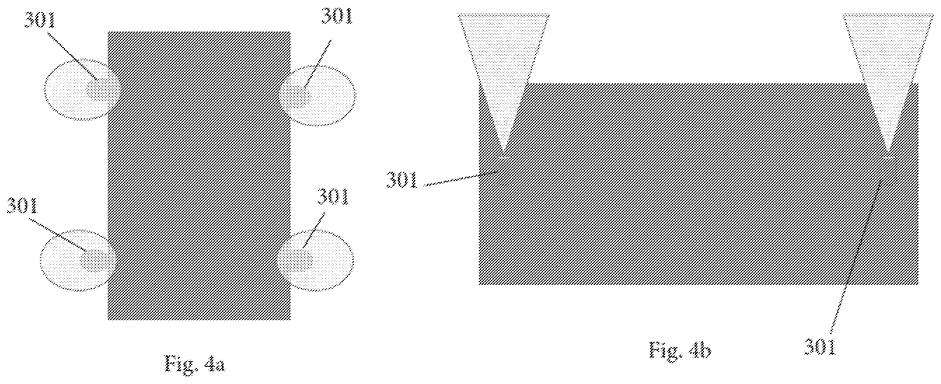

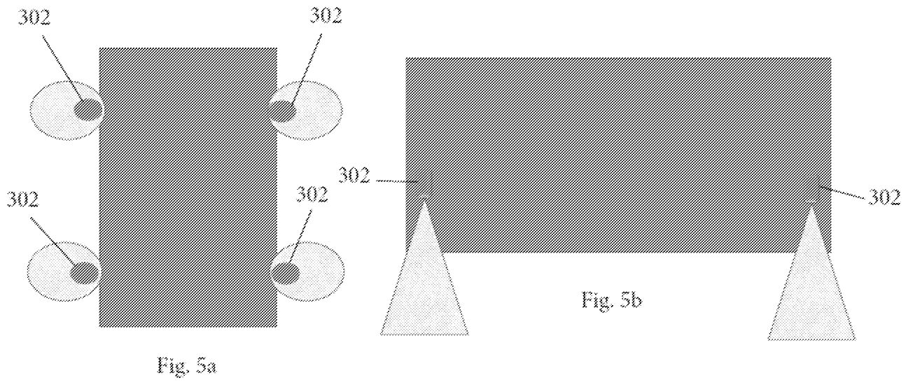

As shown in the plan view in FIG. 4a and the side view in FIG. 4b, to move the ROV 210 downward (i.e., to cause the ROV 201 to dive), all four downward heave nozzles 301 are opened to allow a pressurised flow of water from the water pump 240b to pass through the nozzles 301 and create downward propulsion. Similarly, as shown in the plan view in FIG. 5a and the side view in FIG. 5b, to move the ROV 210 upward (i.e. to cause the ROV 201 to more towards the surface), all four upward heave nozzles 302 are opened to allow a pressurised flow of water from the water pump 240b to pass through the nozzles 302 and create upward propulsion.

### Pitch

The downward heave nozzles 301 and upward heave nozzles 302 can also be used to effect pitching of the ROV 210. To effect pitching upwards (i.e. lifting the bow of the ROV) only the rear downward heave nozzles 301 and/or the front upward heave nozzles 302 may be opened, or alternatively to effect pitching downwards (i.e. lifting the stern of the ROV) only the front downward heave nozzles 301 and/or rear upward heave nozzles 302 are opened.

### Roll

Similarly, the downward heave nozzles 301 and upward heave nozzles 302 can also be used to effect rolling of the ROV 210. To effect rolling to the starboard side, only the starboard side downward heave nozzles 301 and/or the port side upward heave nozzles 302 may be opened, or alternatively to effect rolling to the port side, only the port side downward heave nozzles 301 and/or starboard side upward heave nozzles 302 may be opened.

### Surge

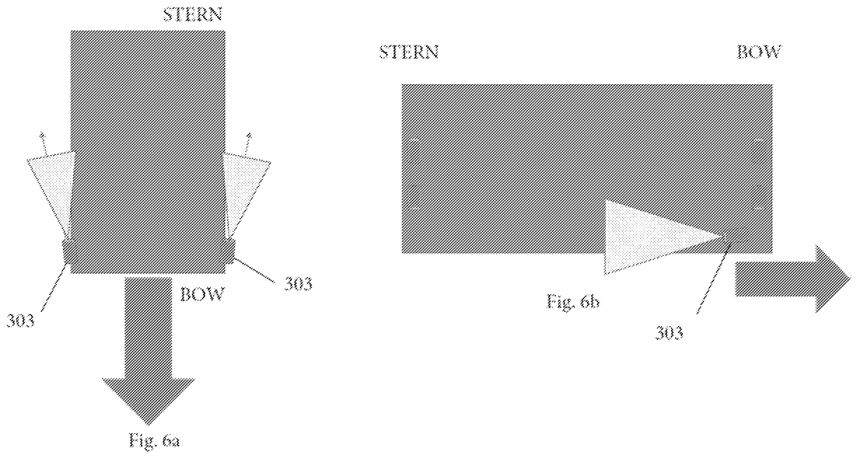

Referring once again to FIG. 3, additionally, each corner further comprises a translational nozzle 303 positioned at an angle to the x-axis as can be seen in the plan view in FIG. 6a and side view in FIG. 6b.

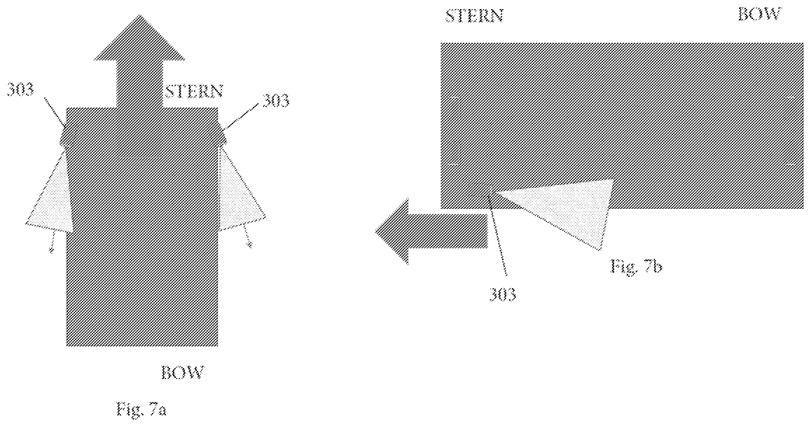

Surge of the ROV 201 is caused by opening only the front translational nozzles 303 as shown in the plan view in FIG. 6a and side view in FIG. 6b (to move the ROV 201 forwards) or by opening only the rear translational nozzles 303 as shown in the plan view in FIG. 7a and side view in FIG. 7b. When the translational nozzles 303 are positioned at an angle to the x-axis as in the current example, both of the rear nozzles 303 or both of the front nozzles 303 must be opened together to move the ROV 201 forwards or backwards and avoid yaw.

### Sway

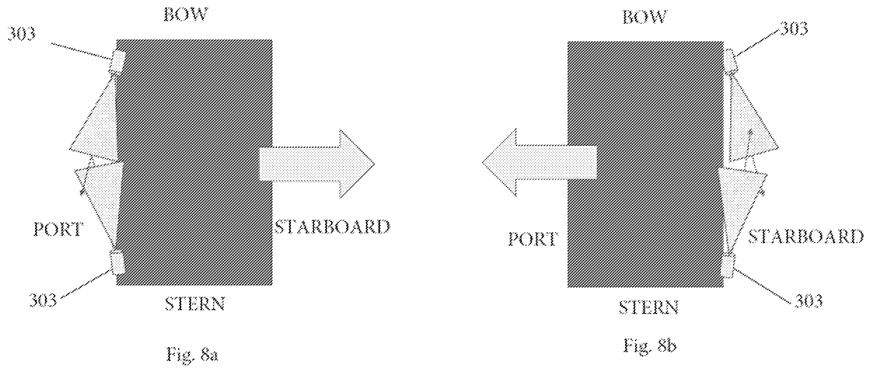

Sway of the ROV 201 is caused by opening only the translational nozzles 303 on one side of the ROV 201 as shown in the plan views in FIG. 8a (sway towards starboard) and FIG. 8b (sway towards port).

When the translational nozzles 303 are positioned at an angle to the x-axis as in the current example, both of the translational nozzles 303 on one side must be opened together to move the ROV 201 towards port or starboard without rotation of the ROV 201.

### Yaw

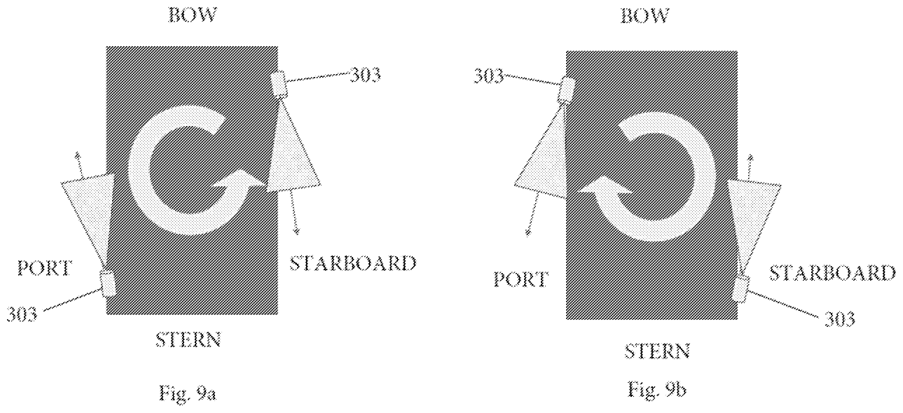

Yaw of the ROV 201 is caused by opening only one translational nozzle 303 or, as in the example shown, supplementing the propulsion caused by the opening of one translation nozzle 303 with the diagonally opposing translational nozzles 303, as shown in the plan views in FIGS. 9a and 9b. For example, to effect yaw counter-clockwise (FIG. 9a) the front starboard translational nozzle 303 is opened together with the rear port translational nozzle 303. To effect yaw clockwise (FIG. 9b) the front port translational nozzle 303 is opened together with the rear starboard translational nozzle 303.

### Steering and Moving

Whilst in the described embodiment the nozzles are configured to steer and move the ROV 201, in some other embodiments the nozzles may be configured to only steer the ROV 201 whilst movement is provided by another method of propulsion such as traditional thrusters. In some other embodiments, the nozzles may be configured to only move the ROV 201 while steering is provided by another method of propulsion such as traditional thrusters. In some embodiments, steering and movement of the ROV 201 are provided by the nozzles and steering and/or movement are supplemented by other forms of propulsion.

It will be understood by the skilled person that although opened/closed nozzles are referred to above, the nozzles may in some embodiments never completely close and instead remain partially open to allow some water to flow therethrough without creating significant propulsion. This may be advantageous to avoid sticking of nozzles in some designs, particularly in ROVs used in increased water depths. Similarly, the nozzles may be arranged to have a variable flow rate such that various degrees of propulsion can be provided, or they may be simply arranged to be open or closed with a generally constant flow rate when the nozzle is opened. A valving arrangement may be provided to provide variable pressure and/or flow at each nozzle.

### Internal Configuration of the ROV

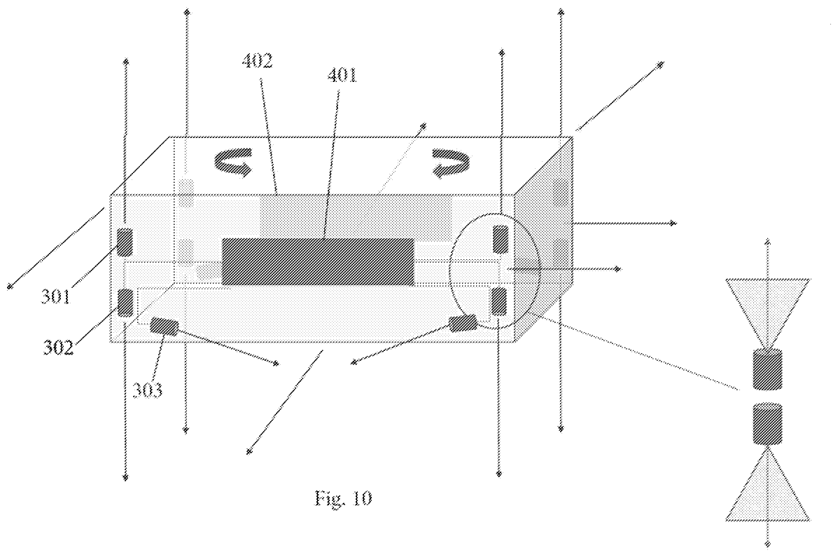

The internal configuration of the ROV 201 is now described with reference to FIGS. 10, 11 and 12.

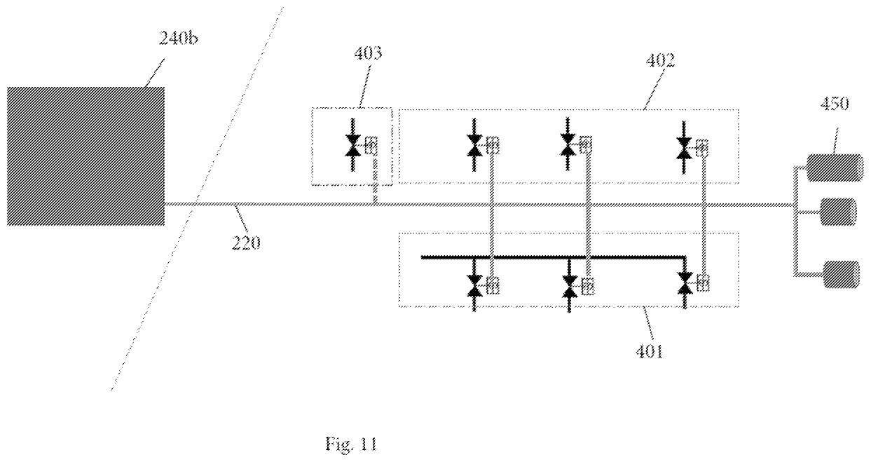

In the presently described embodiment, operation of the nozzles 301, 302, 303 is controlled by a series of valves. The valves are arranged in a starboard valve assembly 401 (shown in FIGS. 10 and 11) which provides control for the nozzles 301, 302, 303 located on the starboard side of the ROV 201, and a port valve assembly 402 which provides control for the nozzles, 301, 302, 303 located on the port side of the ROV 201. In an alternative embodiment, operation of nozzles on the port and starboard sides may be controlled by a single valve assembly.

FIG. 11 shows the electrical connection of the valve assemblies 401, 401 to the control unit 230 via the electrical umbilical 220. The umbilical 220 provides data communications and electrical power to the ROV 201. This includes electrical control signals to the valve assemblies 401, 402 to open and close the valves. It will be appreciated that, depending on the control set up in a particular ROV 201, there may be any number of valves controlling the operation of one or more nozzles. Electrical power and control signals are also provided by the umbilical 220 to auxiliary equipment 450 such as cameras. The ROV 210 may further comprise an auxiliary valve assembly 403 arranged to provide pressurised water to further auxiliary equipment which is powered by or uses high-pressure water to perform work, for example a high-pressure cleaning probe.

Alternatively, to the above-described electrical control of the valves, the valves may instead be controlled by hydraulics, with the provision one or more hydraulic lines from the surface.

Although not shown in the drawings, the ROV 201 may be connected to submersible devices such as the device for collecting fish described in WO2019/135070. Advantageously, when connected to such devices, the hose may be utilised to provide pressurised water to the device. In this regard, the device may be connected to the auxiliary valve assembly 403 as previously described. Alternatively, the device may be attached to a skid or rack of the ROV 201, and the high-pressure hose may provide pressurised water directly to both the device and the valve assemblies 401, 402.

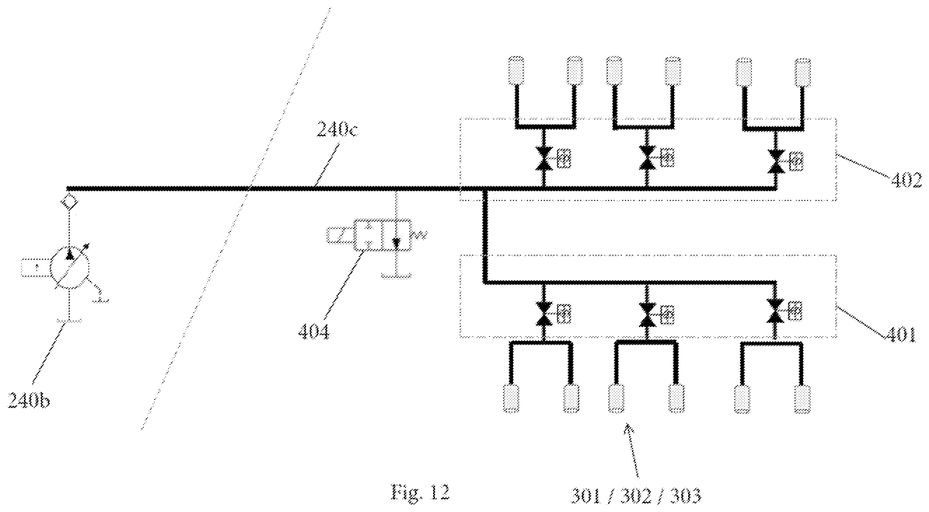

FIG. 12 shows the fluid connection of the nozzles 301, 302, 303 to the pump 240b via the water hose 240c and valve assemblies 401, 402 as previously described. The ROV 201 further comprises a dump valve 404. The dump valve 404 can be controlled in a similar manner to the valves within the valve assembles 401, 402. The dump valve 404 may be controlled by electrical and/or hydraulic control or may be controlled by a passive system such as a spring. When a spring is used, the operating pressure of the dump valve 404 can be pre-determined such that the dump valve 404 will open when required, e.g., when the nozzle or nozzles are closed. The dump valve 404 provides a suitably configured valve and outlet to provide low pressure exhaust of water from the water hose 240c. The dump valve 404 may be operated to allow water flow therethrough when all or most of the valves in the valve assemblies 401, 402 are closed. This provides an exhaust for the pumped water and avoids stalling of the pump 240b.

The dump valve 404 may be connected to a large diameter outlet port (not shown) or a large diameter nozzle (not shown), The outlet port or large diameter nozzle may have a diameter of 1.5 times the diameter of the heave nozzles 301, 302 or translational nozzles 303. In some embodiments, the large diameter outlet port or large diameter nozzle may have a diameter 2, 3, 4, 5 or 6 times larger than the diameters of any of the other nozzles 301, 302, 303. Alternatively, or in addition to the provision of a larger diameter, the dump valve 404 may be connected to a nozzle or outlet port with a diffusion means such as a baffle arrangement to slow and control the flow of water to reduce the propulsion caused by the exhaust of the water.

In some embodiments there may be several dump valves 404 to allow the pressure within the water hose 240c to be released in a controlled manner without causing significant propulsion. In other embodiments there may be one dump valve 404 arranged to provide flow to a plurality of large diameter nozzles or outlets, or nozzles or outlets comprising diffusion means.

In some embodiments there may be a plurality of dump valves 404 arranged such that any propulsion caused by water flow therefrom is balanced by a dump valve 404 providing propulsion in the opposite direction. In such arrangements the dump valves 404 need not comprise large diameter nozzles or diffusion means and may be of substantially similar diameter to nozzles 301, 302, 303.

It will be understood that the control unit 230 will either be configured to allow the user to select operation of the dump valve 404, or preferably the system will automatically open the dump valve 404 when the nozzles 301, 302, 303 are closed. In some embodiments the dump valve 404 may be configured to partially close, i.e., have a variable flow capability. This is advantageous as it allows the dumping of excess pressure when some but not all of the nozzles 301, 302, 303 are closed. In this way, the dump valve 404 assists in ensuring that there is not a significant backpressure generated in the water hose 240c which could stall or damage the pump or cause rupture of the water hose 240c or other equipment such as the valves in the valve assemblies 401, 402.

In some embodiments, the dump valve(s) 404 may be arranged to be always at least partially open in use. In this regard, the dump valve(s) 404 may be positioned substantially vertically such that water released through the dump valve(s) 404 will create propulsion causing either upward heave or downward heave. This can be used to assist in maintaining neutral buoyancy of the ROV 201, and in some embodiments, there may be several dump valves 404 and the user or control system can select which dump valves 404 to bleed excess pressure through to assist with buoyancy control, tidal compensation or any other specific considerations required in the environment and conditions in which the ROV 201 will operate.

### Alternative Arrangement of Dump Valves and Nozzles

Alternatively, to the arrangement described in above and shown in FIG. 3, the ROV 201 may comprise one or a plurality of nozzles which are moveable. In this regard, one or a plurality of nozzles may be moveable between the described positions of the heave nozzles 301, 302 and the translational nozzles 303, or indeed to positions between these points or other positions around the ROV 201. In such an arrangement, the user (or the control system) may work out the desired position of the nozzle to provide the required propulsion, and then move the nozzle using the control unit 230. This allows there to be fewer nozzles, creating a much simpler arrangement. The nozzle(s) may be arranged on mechanical tracks and their movement may be caused by an electric motor, hydraulic arrangement or a physical mechanical connection to the surface such as a pull rod to move the nozzle between different positions.

In any of the previously described embodiments, some or all of the nozzles 301, 302, 303 may have a variable flow rate. Advantageously, some of the nozzles 301, 302, 303 may have a variable flow rate which allows the nozzles to effectively become dump valves 404, whereby the nozzle 301, 302, 303 is able to change shape or configuration enough to reduce the propulsion generated through the nozzle 301, 302, 303 to a sufficiently low level that a dump valve 404 is not required in the system.

Although reference is made to the pumping of water through the pump 240b, water hose 240c and nozzles 301, 302, 303, it will be appreciated that any fluid may be used.

Whilst specific embodiments of the present invention have been described above, it will be appreciated departures form the described embodiments may still fall within the scope of the present invention as defined in the claims.

1. A submersible vehicle comprising:
a plurality of outlet nozzles arranged to receive pressurised fluid from a remote supply and expel the pressurised fluid to create propulsion to manoeuvre the vehicle; and
a plurality of valves in fluid communication with the outlet nozzles and operable to provide variable pressure and/or flow to each outlet nozzle;
wherein the outlet nozzles are arranged about the vehicle to provide six-degrees of freedom movement and control of the submersible vehicle.

2. The submersible vehicle of claim 1, wherein each nozzle is connectable to a distinct/separate supply hose.

3. The submersible vehicle of claim 1, further comprising a manifold operable to receive fluid from a single supply hose, wherein the manifold provides a plurality of outlets, wherein each manifold outlet connects to a corresponding outlet nozzle and supplies pressurised fluid thereto.

4. The submersible vehicle of claim 1, wherein the outlet nozzles are arranged such that expelled fluid from one or a combination outlet nozzles produces at least one of: heave; surge; sway; roll; pitch and yaw motions of the vehicle.

5. The submersible vehicle of claim 1, wherein orientation of one or more of the outlet nozzles has a fixed position on the vehicle.

6. The submersible vehicle of claim 1, wherein orientation of one or more of the outlet nozzles is adjustable.

7. The submersible vehicle of claim 1, wherein the valves are configured to control fluid flow to the outlet nozzles.

8. The submersible vehicle of claim 7, wherein one or more valves are operable to adjust fluid flow to one or more of the outlet nozzles.

9. The submersible vehicle of claim 1, wherein the submersible vehicle includes external corners and wherein each corner includes a downward heave outlet nozzle and an upward heave outlet nozzle.

10. The submersible vehicle of claim 9, wherein each corner includes a translational outlet nozzle, wherein opening forward located translational outlet nozzles only or rearward located translational outlet nozzles only causes translational movement of the vehicle.

11. The submersible vehicle of claim 1, wherein one or more outlet nozzles can open and close.

12. The submersible vehicle of claim 10, wherein one or more outlet nozzles remain permanently open and wherein delivery of fluid to one or more of the outlet nozzles is selective and determined by the required manoeuvre.

13. The submersible vehicle of claim 1, further comprising a dump nozzle, configured to release some or all of the pressurised fluid being delivered to the vehicle.

14. The submersible vehicle of claim 13, further comprising a dump valve configured to control fluid flow from the dump nozzle.

15. The submersible vehicle of claim 1 wherein one or more outlet nozzles and associated valves are configured to allow excess fluid to escape through one or more outlet nozzles even when the vehicle is stationary.

16. The submersible vehicle of claim 1, wherein the vehicle is a remotely operated vehicle.

17. The submersible vehicle of claim 1, wherein the vehicle is an autonomous vehicle

18. A submersible vehicle system comprising:
a submersible vehicle according to claim 1;
a pump;
a control unit connectable to the vehicle by an umbilical; and
a hose connectable to the vehicle, wherein the hose is configured to supply pressurised water via the pump to the vehicle.

19. The system of claim 18 wherein the pump is non submersible.
